(19) United States
(12) Patent Application Publication
(10) Pub. No.: US 2015/0133206 A1
(43) Pub. Date: May 14, 2015

(54) METHOD AND APPARATUS FOR MOBILE REHABILITATION EXERGAMING

(71) Applicant: THE REGENTS OF THE UNIVERSITY OF CALIFORNIA, Oakland, CA (US)

(72) Inventors: Majid Sarrafzadeh, Anaheim Hills, CA (US); Sunghoon Ivan Lee, Los Angeles, CA (US); Jack Bobak Mortazavi, Los Angeles, CA (US)

(21) Appl. No.: 14/397,797

(22) PCT Filed: Mar. 8, 2013
(86) PCT No.: PCT/US13/30045

§ 371 Date: Oct. 29, 2014

Related U.S. Application Data
(60) Provisional application No. 61/640,643, filed on Apr. 30, 2012.

(51) Int. Cl. A63F 13/67; A63F 13/211; A63F 13/212; G06N 99/00

(52) U.S. Cl. CPC A63F 13/67; G06N 99/005; A63F 13/211; A63F 13/212
USPC 463/7

(57) ABSTRACT

An exercise gaming system includes a motion-detect device including a plurality of sensors configured to monitor movement of the motion-detect device during a user motion, and a first processor configured to receive input data from the plurality of sensors and provide information related to the data for transmission via a first wireless communication interface. The exercise gaming system further includes a computing device including a second wireless communication interface configured to receive information transmitted from the motion-detect device, a second processor configured to compare the received information to data stored in a memory and identify the user motion as a predefined movement, and a display configured to visually provide feedback related to the identified predefined movement.

### CROSS-REFERENCE TO RELATED APPLICATION

This application claims the benefit of U.S. Provisional Application Ser. No. 61/640,643 filed on Apr. 30, 2012, titled “Method And Apparatus For Mobile Rehabilitation Exergaming,” the disclosure of which is incorporated herein by reference in its entirety.

### BACKGROUND

Proper performance of many daily activities relies on the ability to precisely control limbs. Medical conditions affecting motor control include Parkinson's Disease, arthritis, various types of tremor, debilitation due to stroke, and post-surgery limitation.

Rehabilitation is generally recommended for improvement of motion due to its effectiveness. However, according to some studies, as few as half of patients consistently adhere to a prescribed rehabilitation plan. Reasons for not adhering to a rehabilitation plan include immobility of the rehabilitation equipment and boredom with the rehabilitation exercises. Thus, it is desirable to have an interesting and portable exercise environment.

### SUMMARY

An exercise game framework is based on determining that a user made a specific motion, where the motion represents one possible movement from a set of predefined movements. The game framework allows faster game design using the set of predefined movements. Further, the exercise game framework may be trained to add new predefined movements to the set of predefined movements.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates an example system for exercise gaming.

FIG. 2 illustrates an example of communication within a computing device.

FIG. 3 illustrates an example process for identifying predefined movements from data corresponding to user motions.

FIG. 4 illustrates a machine learning process using principal component analysis.

FIG. 5 illustrates a machine learning process using support vector models.

FIG. 6 illustrates an example of a motion-detect device.

### DETAILED DESCRIPTION

An exercise gaming system may be used for training, evaluation, or rehabilitation. For example, rehabilitation medicine may be personalized by selecting rehabilitation gaming that is appropriate for a patient. An effective rehabilitation gaming system is portable for use in many different environments and simple enough to use to keep the patient from becoming frustrated. Further, rehabilitation is more effective if it is interesting to the patient over the intended term of rehabilitation.

A simple-to-use, portable exercise gaming system includes a motion-detect device worn or held by a user, and a mobile computing device that wirelessly interfaces with the motion-detect device. The motion-detect device sends information about user motion to the mobile computing device. A game framework on the mobile computing device identifies a predefined movement corresponding to the user motion and provides the predefined movement to a game on the mobile computing device. In this way, the game framework performs the motion data processing, so that a game designer can easily design new games for the gaming system for the set of predefined movements. The simplicity of game design may thus encourage game designers to create multiple new games, such that a user is not bored with the games available. Moreover, the use of a set of predefined movements ensures that the game targets verified movements, such as verified rehabilitation or strength training movements. Movements may be focused on certain goals, such as range of motion enhancement, action enhancement, and grip strength enhancement.

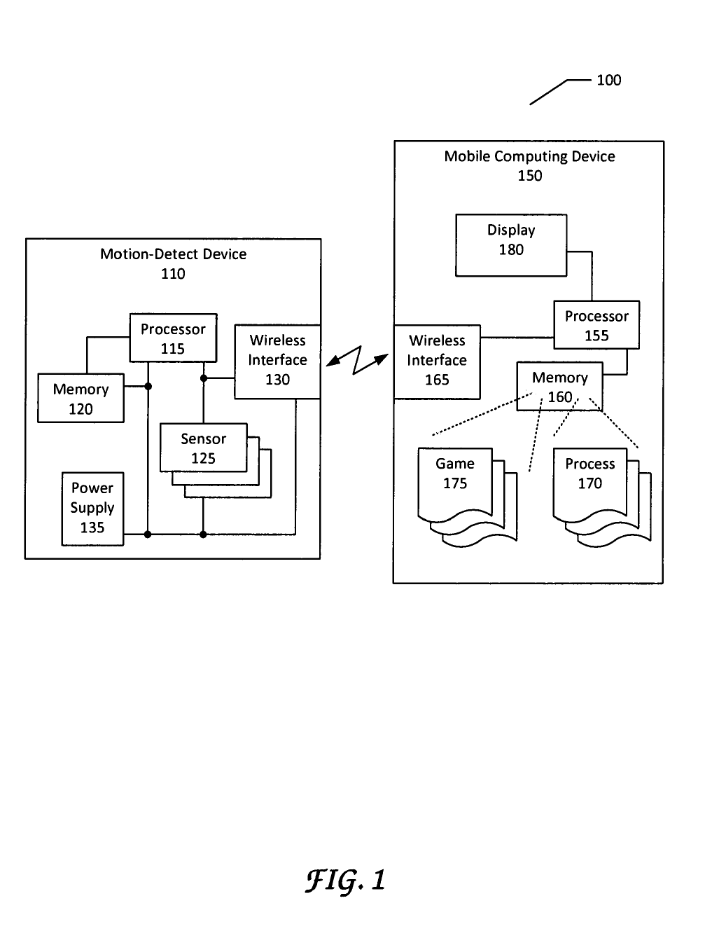

FIG. 1 illustrates an example of a system 100 for exercise gaming. System 100 includes a motion-detect device 110 and a mobile computing device 150. Motion-detect device 110 provides information regarding its motion to mobile computing device 150. Mobile computing device 150 identifies predefined movements from the motion information and may display a visual representation of the identified predefined movements.

Motion-detect device 110 includes a processor 115, a memory 120, one or more sensors 125, a wireless interface 130, and a power supply 135.

Processor 115 is one or more processing devices, where the term processing device includes microprocessor, microcontroller, field-programmable gate array (FPGA), application specific integrated circuit (ASIC), and the like. An example of processor 115 is a 16-bit MSP430 microprocessor from Texas Instruments. Processor 115 may be a combination of processing devices. Processor 115 may read and execute instructions from memory 120. Some instructions may be hard-coded into the design of processor 115.

Memory 120 may be part of processor 115. Additionally or alternatively, memory 120 may be a separate component. Memory 120 may be one of, or a combination of, volatile and non-volatile memory. For example, instructions may be stored in non-volatile memory, and data may be stored in volatile memory.

Sensor 125 may be one or more sensors for detecting motion, position, and pressure. Examples of sensors 125 include accelerometers, gyroscopes, magnetometers, infrared position detectors, radio frequency position detectors, and force sensors. Sensor 125 may output data as current, voltage, frequency, pulse-width modulated (PWM), or other form of signal, in analog or digital format. Sensor 125 may provide sensed data in the form of data words or packets or the like sent via a serial peripheral interface or a parallel peripheral interface. Data from sensor 125 may be filtered for noise and analog-to-digital (A/D) converted as appropriate. Processor 115 reads data from sensor 125 after filtering and conversion. Alternatively or additionally, processor 115 performs filtering and A/D conversion of sensor 125 data. Sensor 125 may additionally be one or more LEDs used as markers for position detectors.

In some embodiments, processor 115 analyzes sensor 125 data to determine if motion has occurred. For example, processor 115 may compare two data points for a difference, or compare a present matrix of data from multiple sensors 125 to one or more previous matrices of data from the multiple sensors 125 to determine if there has been a change greater than a threshold. These examples are not limiting, as there are many other ways of determining if motion has occurred. For embodiments in which processor 115 determines if motion has occurred, processor 115 provides sensor 125 data to mobile computing device 150 through wireless interface 130 when motion is determined, or alternatively upon request. In some embodiments, processor 115 provides sensor 125 data to mobile computing device 150 through wireless interface 130 without determining if motion has occurred.

Wireless interface 130 may be implemented according to a standard or proprietary protocol for wireless information transfer. Examples of standards include Bluetooth, Body Area Network (BAN), and WiFi protocols. Wireless interface 130 transmits information from processor 115 to mobile computing device 150, and receives information for processor 115 from mobile computing device 150. Information may be transferred in packets, and may be encrypted.

Power supply 135 provides power to the components of motion-detect device 110. Power supply 135 includes a battery, which may be a rechargeable battery with recharge circuitry. Power supply 135 may provide different voltage levels and power output on different power buses, depending on the design of the various components of motion-detect device 110.

In some embodiments, motion-detect device 110 may further include other components, such as a vibration device for providing haptic feedback or an audio device for providing audio feedback.

Motion-detect device 110 may be held, worn, or attached to any portion of the body for evaluation or rehabilitation. For example, motion-detect device 110 may be attached to a shoe or other piece of clothing, or may be included on a wearable sleeve, hat, or the like.

Mobile computing device 150 includes a processor 155, a memory 160, a wireless interface 165, processes 170, games 175, and a display 180.

Processor 155 is one or more processing devices, or may be a combination of different processing devices. Processor 155 may read and execute instructions from memory 160. Some instructions may be hard-coded into the design of processor 155. Processor 155 may be similarly implemented as processor 115.

Memory 160 may be part of processor 155. Additionally or alternatively, memory 160 may be a separate component or components. Memory 160 may be one of, or a combination of, volatile and non-volatile memory. Memory 160 may include statistics and performance metrics for completed games and/or training activities. Statistics and performance metrics include scoring. For example, statistics and performance metrics may include that a predefined movement was completed, how close a user motion resembled a predefined movement, how many predefined movements were performed in a sequence, how many predefined movements were not performed, and so on. Statistics and performance metrics may be stored for game portions, for a completed game, and over several games. In this way, a clinician or trainer may monitor progress or identify areas of difficulty.

Wireless interface 165 transmits information from processor 155 to motion-detect device 110, and receives information for processor 155 from motion-detect device 110. Thus, the protocol underlying wireless interface 165 typically will be the same as that implemented for wireless interface 130 of motion-detect device 110.

Wireless interface 165 may further include capability to communicate using another wireless protocol. For example, wireless interface 165 may communicate with motion-detect device 110 using BAN and also communicate through a WiFi or cellular network to an external computing device such as a computer in the user's home or a computer at a clinician's or trainer's office.

Processes 170 are stored as instruction in memory 160 for access and execution by processor 155. Alternatively or additionally, part or all of processes 170 may be hard coded into the design of processor 155. When executed, processes 170 analyze motion information received from motion-detect device 110 and identify corresponding predefined movements. Movement information is made available to games 175. Processes 170 may include machine learning processes such as support vector machine, principal component analysis, and nearest-neighbor clustering processes. Memory 160 may include one or more libraries or databases of predefined movements pre-trained by or for machine learning processes.

Games 175 are stored as instructions in memory 160 for access and execution by processor 155. Games 175 include training or evaluation programs. For example, a user may be shown a movement to make, and the user's motion in response is analyzed. When executed, games 175 use movement information from processes 170 to provide feedback during and after the game. Examples of game feedback will be explained in more detail below by way of example. Feedback includes audio feedback, haptic feedback such as vibration, visual feedback using lights that may be incorporated into mobile computing device 150, and visual feedback on display 180.

Display 180 may be an embedded display of mobile computing device 150, or a display attached to mobile computing device 150. Examples of display 180 include light emitting diode (LED) display, organic LED (OLED) display, active matrix OLED (AMOLED) display, super AMOLED display, liquid crystal display (LCD), thin film transistor (TFT) LCD, in-place switching (IPS) LCD, resistive touchscreen LCD, and capacitive touchscreen LCD. Games, training information, statistics, performance metrics, and movement information related to user motion may be displayed on display 180, providing feedback to the user, clinician, or trainer.

Mobile computing device 150 examples include smartphones, tablets, electronic notepads, computers, and the like.

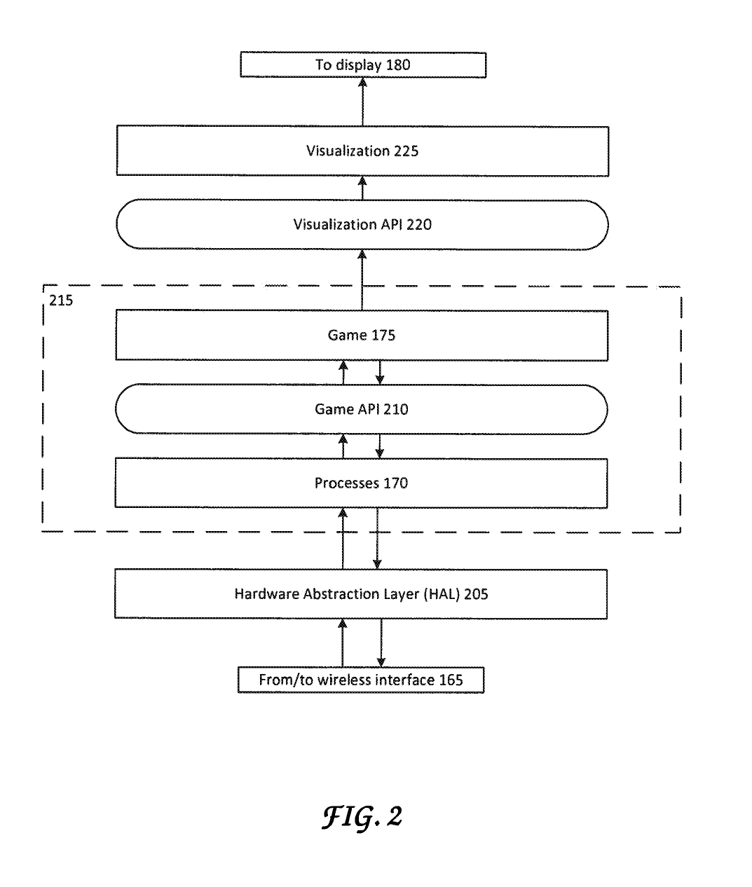

FIG. 2 illustrates an example communication model for the communications within mobile computing device 150. Components of mobile computing device 150 may communicate with each other through various software layers. For example, processor 155 may execute a hardware abstraction layer (HAL) 205 for communication with physical components of mobile computing device 150 such as with wireless interface 165. HAL 205 may include software for converting data received from physical components into data formatted for processes 170 executed by processor 155. For example, HAL 205 may extract data embedded within wireless protocol packets and convert the extracted data to serial or parallel bits.

Processor 155 may include a game environment 215 that receives motion information from HAL 205 and outputs display information. Game environment 215 may include processes 170, game application programming interface (API) 210, and a presently-running game 175. Processes 170 were previously described. Game API 210 may be an interface for passing standardized movement information to game 175 from processes 170 and for passing parametric information from game 175 to processes 170. Standardized movement information may allow for targeting game design to a certain number of verified movements for a category of games 175, such as a “shoulder strength” or an “ankle flexibility” category, to prevent stressing the exercised portion of the body. Game environment 215 may be started by selecting an icon or other link representing game environment 215 from a display of icons or links, and a specific game 175 may then be started from within game environment 215. Alternatively, game environment 215 may be started by selecting an icon or other link representing a specific game 175 from a display of icons or links, and game 175 then starts game environment 215. Game environment 215, in some embodiments, may remain running while one game 175 is closed and another game 175 is opened.

Game 175 and/or game environment 215 communicates with visualization 225 through visualization API 220. Visualization 225 controls display 180.

Thus, motion information received at wireless interface 165 is converted at HAL 205 and translated into predefined movements by processes 170. The predefined movements are provided to game 175 through game API 210, and movement information is sent to visualization 225 through visualization API 220 for presentation at display 180.

The processes, APIs, and other portions of computing device 150 illustrated in FIG. 2 are by way of example to provide better understanding of the concepts in this disclosure, but are not limiting. Other processes, APIs, software layers and the like may be part of game environment 215 and mobile computing device 150. For example, in addition to visualization 225, there may be audio or haptic layers. Further, some processes, APIs, software layers and the like may eliminated, separated or combined, such as combining processes 170 and game 175 and eliminating game API 210.

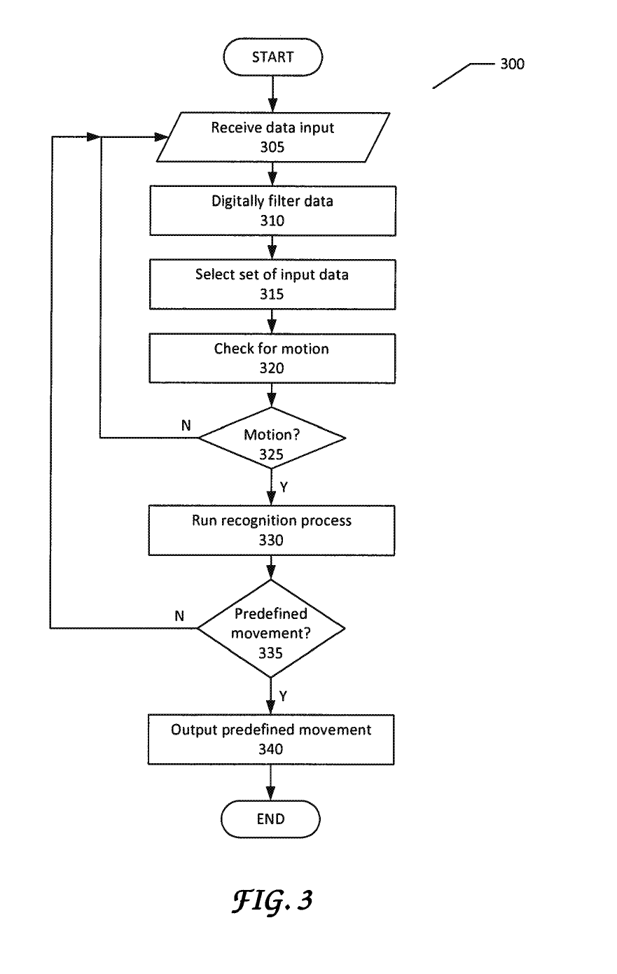

FIG. 3 illustrates an example process 300 for determining if a predefined movement has been performed by a user. Process 300 begins at block 305 upon the receipt of data, which may be receipt of data from motion-detect device 110 through wireless interface 165, or may be receipt of data from memory 160.

At block 310, the received data may be digitally filtered, for example, with digital low pass, high pass, band pass, notch, comb, or other filter. Filtering may also include data fusing, in which input data from multiple sensors 125 is combined into one data output. Received data that is motion data from motion-detect device 110 may already in part represent fused data from multiple sensors 125.

At block 315, a set of the data received (block 305) and filtered and/or fused (block 310) is selected. A set of data may be selected through use of a window of a desired length, such as a sliding window. Window size may be selected according to the minimum length of a predefined movement. For example, a window may include enough data to represent a full tennis swing, or may include enough data to represent a finger move upwards by a fraction of an inch. In some embodiments, a game 175 defines window length. In other embodiments, one of processes 170 defines window length. Data may be normalized within a window for comparison with other windowed data.

At block 320, the set of data is analyzed for motion. For example, the present set of data may be compared with a previously selected set of data for differences in value or for extent of correlation. In some embodiments, a set of data is analyzed to determine if a motion is one or more predefined sub-movements, where multiple sub-movements may make up a predefined movement. An example of a movement with sub-movements is a pounding movement with sub-movements of fingers gripping, arm rotating up, arm rotating down, and acceleration downward.

At decision block 325, if motion was not detected (or not identified as a predefined sub-movement) at block 320, process 300 returns to block 305 to receive data. Otherwise, process 300 continues at block 330.

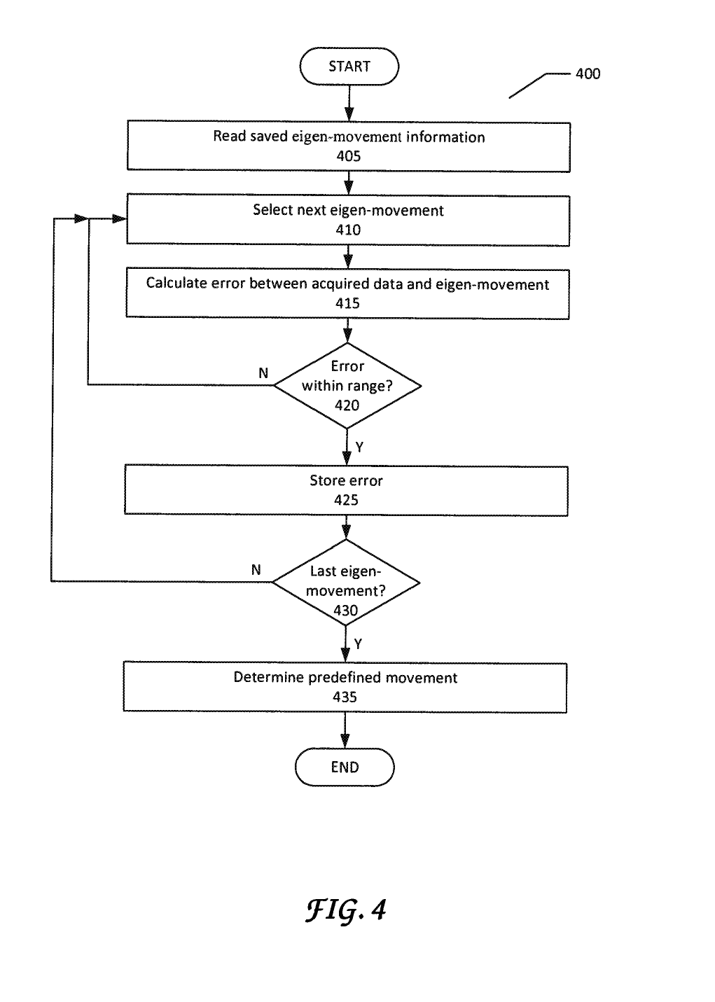

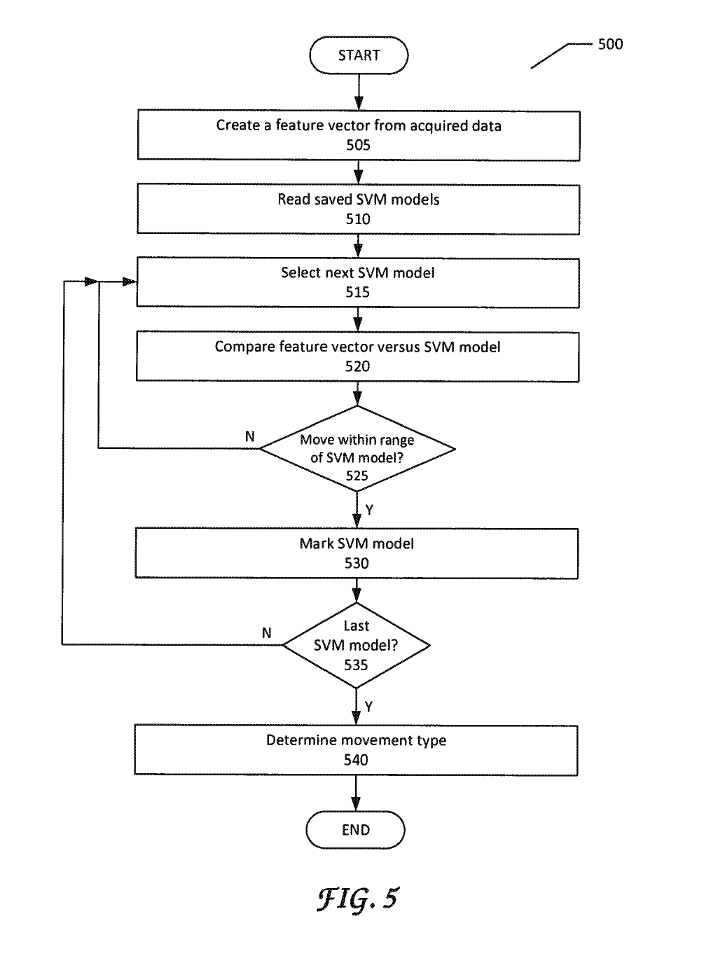

At block 330, a recognition process is performed. Examples of recognition processes that are machine learning processes are illustrated in FIGS. 4 and 5. The recognition process determines whether a motion or sequence of sub-movements qualifies as a predefined movement, and if not, process 300 returns to block 305 to receive data. Otherwise, process 300 continues at block 340. In some implementations, movements are described by classes, and one class is a null class, such that motions not fitting into any other class are part of the null class. The null class may include motions such as accidentally dropping an object.

At block 340, if the motion was a predefined movement, the predefined movement is output to memory or to a presently-running game. In some embodiments, movements in a null class are discarded, and in other embodiments, movements in a null class are output at block 340. Following block 340, process 300 ends.

In some embodiments, process 300 is fully implemented within processor 155 of mobile computing device 150. In other embodiments, portions of process 300 may be performed within processor 115 of motion-detect device 110. For example, processor 115 may perform one or more of digitally filter data (block 310), select a set of input data (block 315), and check for motion (block 320) before providing data to mobile computing device 150. In some embodiments, process 300 is fully implemented on processor 115 of motion-detect device 110, and predefined movement is outputted (block 340) to mobile computing device 150, which may provide predefined movement to memory 160 or to the presently-running game.

Process 300 is illustrated by blocks in a particular order. However, some blocks may be omitted, others may be added, and some may be reordered. For example, one or more of digital filtering (block 310), selecting a set of input data (block 315) or checking for motion (block 320) may be omitted or reordered.

FIG. 4 illustrates one example of a recognition process 400 that may be implemented as block 330 of process 300. Process 400 uses a principal component analysis to determine predefined movement. Process 400 begins at block 405 to read a set of one or more eigen-movements, from memory 160. For example, process 400 may access a beginning address in memory 160, or a link to an entry or list or the like in memory 160. Each eigen-movement represents a different predefined movement, and each eigen-movement may include one or more eigenvectors, and may further include other information such as average or mean values for related movement data. Some examples of predefined movement include a movement of a certain distance and/or velocity, movement in an arcuate motion, and movement over a distance followed by a grip motion.

At block 410, an eigen-movement is selected from the set of eigen-movements.

At block 415, an error is calculated between acquired data and the selected eigen-movement. Acquired data may be data that was previously received from motion-detect device 110, stored in memory 160, and subsequently retrieved from memory 160. Alternatively, acquired data may be near real-time data received from motion-detect device 110, a set of data selected at block 315 of process 300, or a sub-movement determined at block 320 of process 300. Acquired data may be sensor 125 data, or may be filtered data from sensors 125.

At decision block 420, if the error determined in block 415 is not within a predefined range, meaning that the acquired data is most likely not the movement described by the eigen-movement, process 400 proceeds to block 410 to analyze the next eigen-movement. If the error determined in block 415 is within a predefined range, the determined error for that eigen-movement is stored at block 425.

At decision block 430, if there are more eigen-movements to analyze, process 400 continues at block 410 to analyze the next eigen-movement. If all eigen-movements have been analyzed, process 400 proceeds to block 435.

At block 435, the errors stored at block 425 are analyzed, and a predefined movement is selected based on the errors. For example, the selected predefined movement may be the predefined movement represented by an eigen-movement with the least error.

FIG. 5 illustrates another example of a recognition process 500 that may be implemented as block 330 of process 300. Process 500 is similar to process 400, but uses a support vector machine (SVM) instead of a principal component analysis. Process 500 begins at block 505 to create a feature vector of features in acquired data. Acquired data may be data that was previously received from motion-detect device 110, stored in memory 160, and subsequently retrieved from memory 160. Alternatively, acquired data may be near real-time data received from motion-detect device 110, a set of data selected at block 315 of process 300, or a sub-movement determined at block 320 of process 300. Acquired data may be sensor 125 data, or may be filtered data from sensors 125. Features in a feature vector may include duration, force, intensity of motion in a certain direction, displacement of the movement, and the like. A feature vector in one example describes the order in which motion peaks occur in data from different sensors 125, along with measured grip strength across a time window.

At block 510, SVM models are read. For example, process 500 accesses a beginning address in memory 160, or a link to an entry or list or the like in memory 160.

At block 515, an SVM model is selected, and at block 520, the selected SVM model is compared to the feature vector created at block 505.

At decision block 525, if the feature vector is not within the range of the selected SVM model, process 500 continues at block 515 with the next SVM model. Otherwise, process 500 continues at block 530 to mark the SVM model.

At decision block 535, if there are more SVM models to analyze, process 500 continues at block 515 to analyze the next SVM model. If all SVM models have been analyzed, process 500 proceeds to block 540.

At block 540, the marked SVM models are analyzed, and a predefined movement is selected based on the SVM model most similar to the feature vector. For example, the selected predefined movement may be the predefined movement represented by an SVM model with the highest correlation to the feature vector. In an alternative embodiment, rather than comparing individual SVM models (blocks 515-540), a multi-class SVM model is used to select a predefined movement in one iteration of process 500.

FIGS. 4 and 5 illustrate two examples for recognizing a predefined movement from acquired data. Different processes for recognizing predefined movement are within the scope of this disclosure. A process for recognizing predefined movement such as a machine learning process may be trained by performing movements in sequence in a training mode.

Having generally described a system and processes related to motion-detect device 110 and mobile computing device 150, one specific example of motion-detect device 110 is next described.

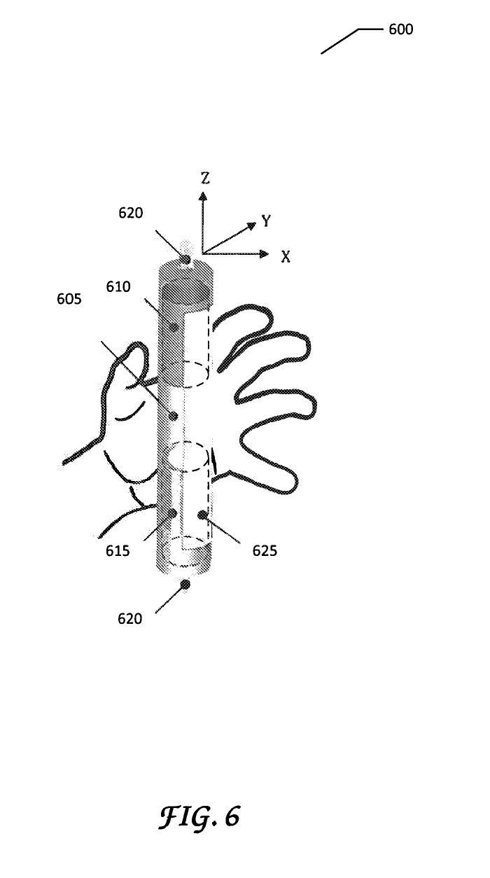

FIG. 6 illustrates a hand-held grip cylinder 600, which is one example of motion-detect device 110. Grip cylinder 600 includes a body 605 which includes a processor 610, a battery 615, two position sensors 620, and one or more pressure sensors 625.

Body 605 is sized to be comfortably held in a hand. Thus, one implementation of body 605 may be sized for large hands, one for small hands, one for a child's hands, and so on. Body 605 is preferably a lightweight solid or semi-solid structure. For example, body 605 may be formed from aluminum, carbon fiber, or plastic such as a Delrin plastic. In one implementation, body 605 is approximately one to three centimeters (1-3 cm) in radius and ten to fifteen centimeters (10-15 cm) in length.

Processor 610 may be a processor such as processor 115 described with respect to FIG. 1.

Battery 615 may be a battery sized for the power needs of grip cylinder 600, and may be rechargeable through a wired or wireless connection.

Position sensors 620 may sense position relative to a fixed point. For example, position sensor 620 may emit a signal such as an infrared or other frequency signal that is reflected from a fixed point or points and the reflection is received by sensor 620 for analysis of distance traveled by the reflection. The distance traveled may provide a two-dimensional (2-D) or three-dimensional (3-D) indication of sensor 620 position in a virtual 2-D or 3-D space, respectively. Alternatively, position sensors 620 may emit light that is sensed externally for determining position information of grip cylinder 600. For example, position sensors 620 may be LEDs at a visual or infrared frequency, where the light is sensed by a camera or other light-sensing device connected to mobile computing device 150.

Pressure sensor 625 detects pressure from the fingers of the hand. Multiple pressure sensors 625 may be implemented to provide fine resolution of grip force, thereby identifying pressure from specific fingers individually.

Grip cylinder 600 may include more or fewer components than those shown. For example, grip cylinder 600 may include motion or acceleration sensors, or may omit one or both position sensors 620. For another example, grip cylinder 600 may include haptic or audio output devices.

Grip cylinder 600 is used to provide input into a game, for example input to a game 175 through processes 170. One example of a game is Smack-a-Yak, in which a user attempts to smack a virtual depiction of a yak when the yak pops into view on a display. To smack the yak, the user grasps grip cylinder 600 and moves it in a quick arc downward. Processes 170 recognize the grasping and the arc downward as predefined movements, which are provided to the Smack-a-Yak game. The Smack-a-Yak game may display a representation of the movements, for example by providing visualization APIs 220 to visualization layer 225. The game may display a stick hitting or missing the yak, and may display a graduated surprise response of the yak depending on the acceleration of the downward arc of grip cylinder 600. Additionally, the yak may vocalize depending on the acceleration or positioning of the downward arc. Further, the Smack-a-Yak game may provide a command to grip cylinder 600 to provide vibration or audio feedback if a haptic or audio feature is available in cylinder 600. For additional time-related feedback, the yak may run away if not smacked within a certain time of appearing on the display.

The Smack-a-Yak game and grip cylinder 600 are described for context. Other games at varying levels of complexity and other motion-detect devices 110 may be created according to the concepts of this disclosure. For example, a football-style game may be created to interface with motion-detect device 110 worn on the leg to exercise certain portions of the knee. Other games may incorporate movements for evaluating or improving range of motion, large motor control, fine motor control, shaking, strength, agility, speed, and the like.

In some embodiments, mobile computing device 150 provides instruction for a motion to perform and monitors for performance of the motion through vision detection. For such embodiments, fewer sensors 125 may be implemented in motion-detect device 110, as the vision detection recognizes motion and thus motion sensors 125 may be omitted.

Performance of a game may be tracked over several different metrics. For example, speed, accuracy, delay, frequency, range of motion, strength, and the like may be monitored for each of several movements such as gripping, slicing, lifting and the like. Performance metrics may be stored and may be displayed in a visual manner.

Game design may be controlled for appropriate movements by providing game requirements, such as the number, types, and sequences of acceptable and/or required movement to be included in the game. Game requirements may also include requirements on performance metrics and evaluation. For example, game requirements may include requirements on identifying accuracy, delay, weakness, or fatigue. Game requirements may also include requirements for adjustment of the game level to increase difficulty over time, or to reduce difficulty if fatigue is recognized.

Thus has been described an easy-to-use, portable, reduced-cost system with near real-time filtering, data processing and pattern recognition, that may be used in rehabilitation, evaluation, physical training such as for sports, or in other activity training

### CONCLUSION

An embodiment of the invention relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) via a transmission channel. Another embodiment of the invention may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or reordered to form an equivalent method without departing from the teachings of the invention. Accordingly, unless specifically indicated herein, the order and grouping of the operations is not a limitation of the invention.

1. An exercise gaming system, comprising:
a motion-detect device including:
a plurality of sensors configured to monitor movement of the motion-detect device during a user motion;
a first wireless communication interface; and
a first processor configured to receive input data from the plurality of sensors and provide information related to the data for transmission via the wireless communication interface; and
a computing device including:
a second wireless communication interface configured to receive information transmitted from the motion-detect device;
a first memory;
a second processor configured to compare the received information to data stored in the memory and identify the user motion as a predefined movement; and
a display configured to visually provide feedback related to the identified predefined movement.

2. The exercise gaming system of claim 1, wherein the motion-detect device is configured for attachment to an article of clothing.

3. The exercise gaming system of claim 1, wherein the motion-detect device is configured to be handheld.

4. The exercise gaming system of claim 1, the motion-detect device further including a second memory with a plurality of stored sets of data representing respectively a plurality of features;
wherein the first processor is further configured to compare a set of the input data from the plurality of sensors with each of the plurality of stored sets of data and determine a most likely feature of the plurality of features based on the comparison, and wherein the information provided by the motion-detect device is the determined most likely feature.

5. The exercise gaming system of claim 1, the computing device further including a plurality of stored sets of data in the first memory representing respectively a plurality of features;
wherein the second processor is further configured to compare a set of the information received from the motion-detect device with each of the plurality of stored sets of data and determine a most likely feature of the plurality of features based on the comparison.

6. The exercise gaming system of claim 1, wherein the second processor is configured to identify the user motion as the predefined movement by using a machine learning process.

7. The exercise gaming system of claim 6, wherein the machine learning process includes a principal component analysis.

8. The exercise gaming system of claim 6, wherein the machine learning process includes a support vector model.

9. A system, comprising:
a wireless interface configured to communicate with a motion-detect device;
a memory storing data representing a plurality of predefined movements;
a display; and
a processor configured to:
receive data through the wireless interface from the motion-detect device, the received data representing motions made by a user in relation to the motion-detect device;
compare the received data to the stored data;
determine from the comparison that the received data corresponds to a predefined movement of the plurality of predefined movements; and
provide display information to the display related to the determined predefined movement.

10. The system of claim 9, the memory further storing data representing a plurality of predefined sub-movements, wherein at least one of the plurality of predefined movements includes multiple predefined sub-movements;
wherein the processor is further configured to compare a portion of the received data with the data representing the plurality of predefined sub-movements and identify a most likely sub-movement.

11. The system of claim 9, wherein the processor is configured to determine that the received data corresponds to the predefined movement by using a machine learning process.

12. The system of claim 11, wherein the machine learning process includes a principal component analysis.

13. The system of claim 11, wherein the machine learning process includes a support vector model.

14. The system of claim 9, the processor is configured to execute a rehabilitation framework process and a game process, the processor further configured to pass information between the rehabilitation framework process and the game process, wherein the comparing and determining is performed in the rehabilitation framework process, and the determined predefined movement is passed to the game process.

15. The system of claim 9, wherein the processor is further configured to execute a sports training game based on the determined predefined movement.

16. An apparatus, comprising:
a plurality of sensors configured to monitor motion of the apparatus during a user motion;
a memory with a plurality of stored sets of data representing respectively a plurality of movement features;
a wireless communication interface; and
a processor configured to:
compare a set of input data from the plurality of sensors with each of the plurality of stored sets of data and determine a most likely movement feature of the plurality of movement features based on the comparison; and
provide the determined most likely feature for transmission via the wireless communication interface.

17. The system of claim 16, wherein the plurality of movement features are predefined sub-movements of a set of predefined movements.

18. The system of claim 16, wherein the plurality of movement features are related to predefined support vector models.

19. The system of claim 16, wherein the plurality sensors include one of an accelerometer and a pressure sensor.

20. The system of claim 16, further comprising a body housing at least one of the plurality of sensors, the memory, the communication interface, and the processor, where the body is sized to be handheld.
